(19) United States
(12) Patent Application Publication
(10) Pub. No.: US 2016/0369466 A1
(43) Pub. Date: Dec. 22, 2016

(54) HEATING PAD APPLIED FOR MELTING SNOW ON ROADS

(71) Applicant: APOLLO SUN GLOBAL CO., LTD., San Jose, CA (US)

(72) Inventor: RICHARD CHI-HSUEH, SAN JOSE, CA (US)

(21) Appl. No.: 15/083,608

(22) Filed: Mar. 29, 2016

Related U.S. Application Data
(60) Provisional application No. 62/230,915, filed on Jun. 17, 2015.

(51) Int. Cl. E01H 5/10; H05B 1/02; H05B 3/36

(52) U.S. Cl. CPC E01H 5/10; H05B 3/36; H05B 1/0222

(57) ABSTRACT

The invention relates to a heating pad for melting snow on roads. The heating pad mainly comprises an upper and a lower insulating layers for waterproofing and current leakage preventing, a fixed wrapping clothe layer, and a conductive heating fabric wrapped by the upper and the lower insulating layers. The conductive heating fabric is woven by conductive yarns as warps, and metal conductive wires as wefts. In addition, the conductive yarns each comprises a nonconductive axial yarn and a fine metal filament winding on the axial yarn. The fine metal filament winds outside the axial yarn to form a stretchable and flexible conductive yarn. Therefore, the woven conductive heating fabric is coated by an insulating layer made by rubber, plastic or silicone to form the heating pad having conductive heating effect. The heating pad can be applied on trails or lanes outside garages to melt snow in the winter outdoors.

### CROSS REFERENCE TO RELATED APPLICATION

This application claims the benefits from U.S. Provisional Application No. 62/230,915, filed on 17 Jun. 2015, the subject matter of which is incorporated herein by reference.

### BACKGROUND OF THE INVENTION

Field of Invention

The disclosure relates to a heating pad applied for melting snow on roads. More particularly, the disclosure relates to a first-invented heating pad used on trails and lanes outside garages in cold snowing area to provide a heating pad structure for melting snow on roads in winter outdoors.

Description of Related Art

In the areas or countries in high latitudes, it will inevitably encounter snowy weather in winters. In the snowy seasons, the temperature drops quickly, and the indoor space is the warmest space since the heaters and the radiators warm up the indoor space. However, the outdoor roads are covered by snow. Especially, it is unable to move after blizzards. How to solve the problem? The usually used methods include using shovels or brooms to clean the accumulated snow on sidewalks and lanes. When the accumulated snow is seriously thick, snowplows are used to clean the ice and snow on roads, or deicing salts will be sprayed to melt the snow on roads. The deicing salts includes CH₃COOK and chloride salts, such as NaCl, KCl, CaCl₂, or MgCl₂. The mostly used is industrial NaCl salt. Using the deicing salts is benefit to the traffic, but harmful to the roads, plants and water.

Furthermore, snow melting devices are also installed in the floor layers of roads. The heating sources of the warn air for melting snow used by these traditional snow melting devices are electric heat, gas heat, and geothermal water pipes. The heat conductive way is transferring warm gas to every corners of the outdoor sidewalks. The principle of heating by geothermal water pipes is heating the floor on the geothermal water pipes first and transferring the heat through bricks, and the warn air then floats upward. Therefore, the surface of the floor cannot feel the temperature immediately, and it needs a long preheated time (48 hours). The electricity and heat transferring lost is thus quite significant to reach an outdoor preset temperature. Since the heat transferring lost is as high as 45% above, the drawbacks of significant warn air loss and electricity consumption are thus produced.

Therefore, in view of drawbacks of the prior arts, the inventors develop this invention by the many-year manufacturing and design experience and knowledge in the related fields and ingenuity. A heating pad for melting snow on roads is provided to reach better practical and valuable purposes.

### SUMMARY

A main purpose of this invention is to provide a heating pad that can be applied on melting snow on roads. A spirally-winding fine metal filament is used to weave a conductive yarn that can generate heat by electrically conducting, and the conductive yarn can be further woven to form a heating fabric to be applied on trails or lanes outside garages to melt snow on roads in cold snowing areas. Therefore, the heating pad can be a snow-melting heating pad used in winter outdoors in snowing areas.

The purposes and effects of the heating pad in this invention are realized by the following technologies.

The heating pad comprises an upper and a lower insulating layers for waterproofing and current leakage preventing, a fixed wrapping cloth layer, and a conductive heating fabric wrapped by the upper and the lower insulating layers. The conductive heating fabric is woven by conductive yarns and metal conductive wires to be warps and wefts. The conductive yarns each comprises a nonconductive axil yarn and a fine metal filament guided by a device to spirally wind outside the axial yarn. The fine metal filament spirally winds on the axial yarn to form a stretchable and flexible conductive yarn. The woven conductive heating fabric is wrapped in the insulating layers made by rubber, plastic, or silicone to form a heating pad having conductive heating effect. The heating pad can be applied on trails or lanes outside garages in cold snowing areas to be the best snow melting device in winter outdoors to achieve the advantages of easy using.

In the heating pad for melting snow on roads, a device for manufacturing conductive yarns comprises a pedestal, a shaft seat on the pedestal, an axial rod embedded in the shaft seat and having a through hole in the central, a base sleeved on the axial rod, a rotating wheel set below the base, a reel wound by the fine metal filament and embedded above the base, a motive power source set up on the base, a driving wheel driven by the motive power source and engaged with the rotating wheel, a spindle seat wound by the axial yarn correspondingly penetrating the central through hole and set below the base, as well as a furling wheel set above the pedestal. Therefore, the furling wheel and the motive power source is turned on to drive the axial rod, rotate the reel and coordinate with the furling wheel to rotate and pull the axial yarn to let the fine metal filament is parabolically thrown out to spirally wind outside the axial yarn by following the operation speed of the device.

In the heating pad applied on melting snow on roads, the conductive heating fabric comprises nonconductive textile yarns and multiple metal conductive wires as warps as well as conductive yarns as wefts. The fine metal filament spirally winding outside the conductive yarn and the metal conductive wires are alternatively woven to form the conductive heating fabric having a well conducting path.

In the heating pad applied on melting snow on roads, the conductive heating fabric is connected to a power supply unit for converting an AC power of 110-220 V to a DC power of 6 V, 12 V, 24 V, or 48 V.

In the heating pad applied on melting snow on roads, the heating pad is formed by fixing several conductive heating fabrics on the fixed wrapping cloth layer by sewing by a machine or any other fixing method. In addition, the adjacent conductive heating fabrics are electrically connected, and then wrapped by the upper and lower insulating layers to laminate the upper and lower insulating layers as well as the fixed wrapping cloth layer. A connection port is electrically connected to the conductive heating fabric and set outside the upper and lower insulating layers. The connection port is correspondingly connected to an output wire of the power supply to conduct electricity.

In the heating pad applied on melting snow on roads, the upper and lower insulating layers can be made of an insulating material selected from plastic, rubber, and silicone.

From the composed elements and implemental illustrations above, it can be known that this invention has the following advantages compared with the available structures:

1. In the heating pad for melting snow on roads of this invention, the nonconductive axial yarn is pulled up by a device, and a fine metal filament spirally circulate outside the surface of the axial yarn to have an effect of not being easily pulled off as well as soft and flexible.

2. The heating pad for melting snow on roads of this invention will expand with heat and contract with cold when the spirally-winding fine metal filament is electrically conducted to generate heat to have well stretchable properties.

3. The heating pad for melting snow on roads of this invention is set up for melting snow on trails or lanes outside garages. The heating pad can be automatically turned on when it snows by a temperature sensor to reach an effect of easy using.

4. Compared with the electricity consumption of the various traditional devices of geothermal water pipes, the heating pad of this invention can save more than 45% of electricity.

### BRIEF DESCRIPTION OF THE DRAWINGS

FIG. 1 is a diagram showing a heating pad applied for melting snow on roads according to this invention.

FIG. 2 is a diagram showing an appearance of a heating pad according to this invention.

FIG. 3 is a separating diagram showing a heating pad according to this invention.

FIG. 4 is a diagram of an axial yarn of this invention.

FIG. 5 is a diagram of a fine metal filament of this invention.

FIG. 6 is a diagram of a conductive yarn of this invention.

FIG. 7 is a diagram of a conductive wire of this invention.

FIG. 8 is a diagram of a device architecture in this invention.

FIG. 9 is a diagram of a conductive heating fabric according to this invention.

### DETAILED DESCRIPTION

To more completely and clearly illustrate the technical means and effects of this invention, the detailed descriptions are set forth below. Please refer to the disclosed figures and the reference numbers.

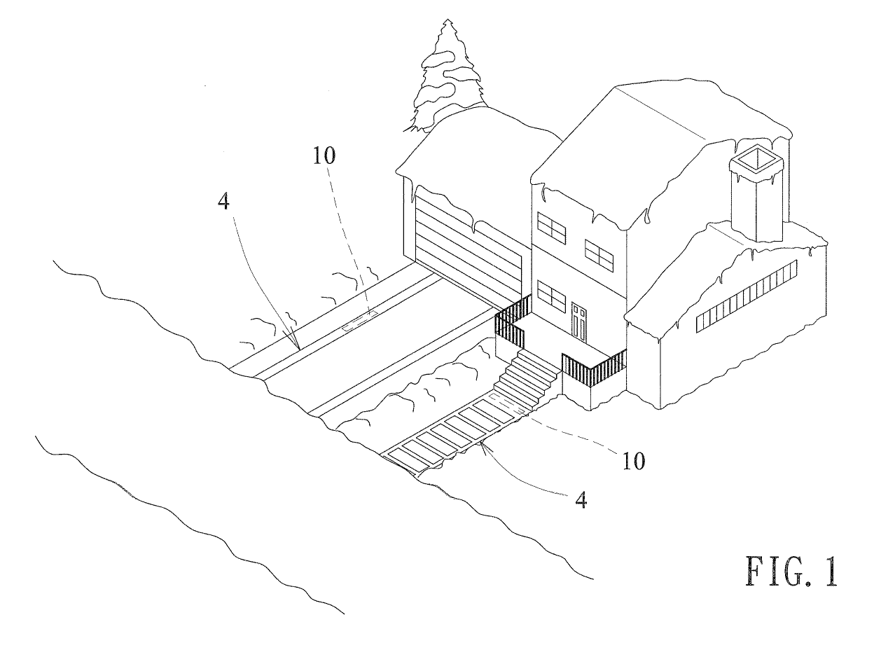

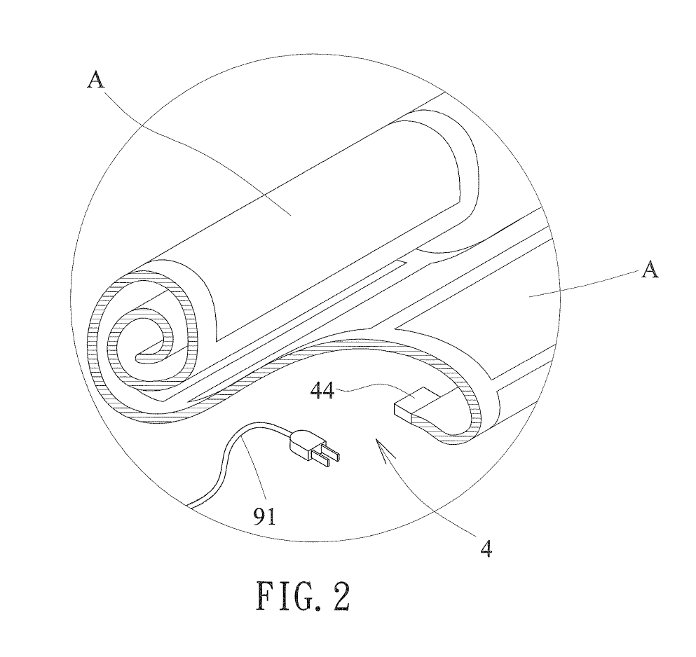

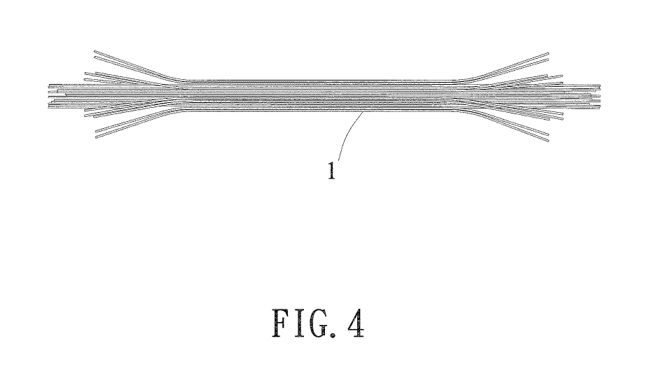

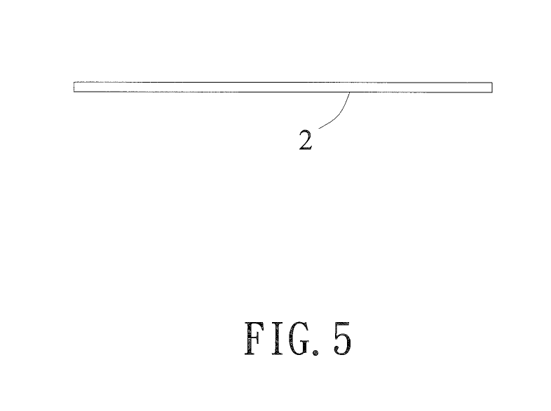

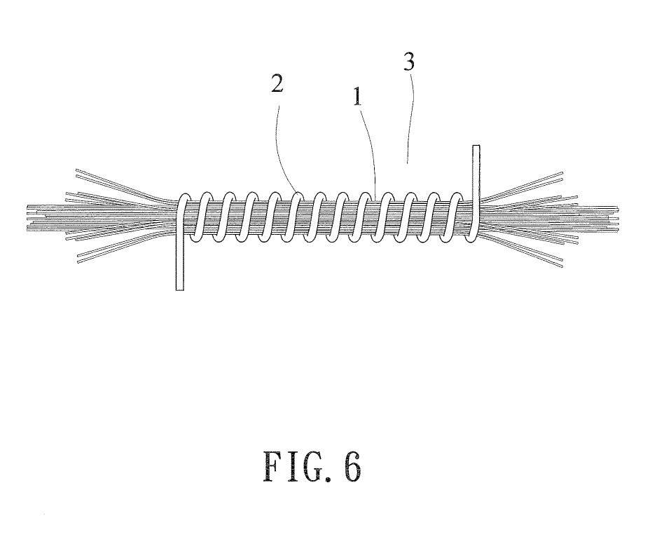

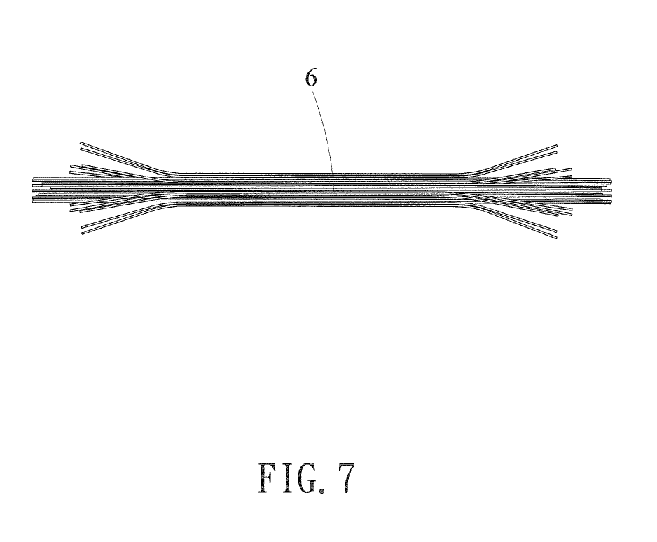

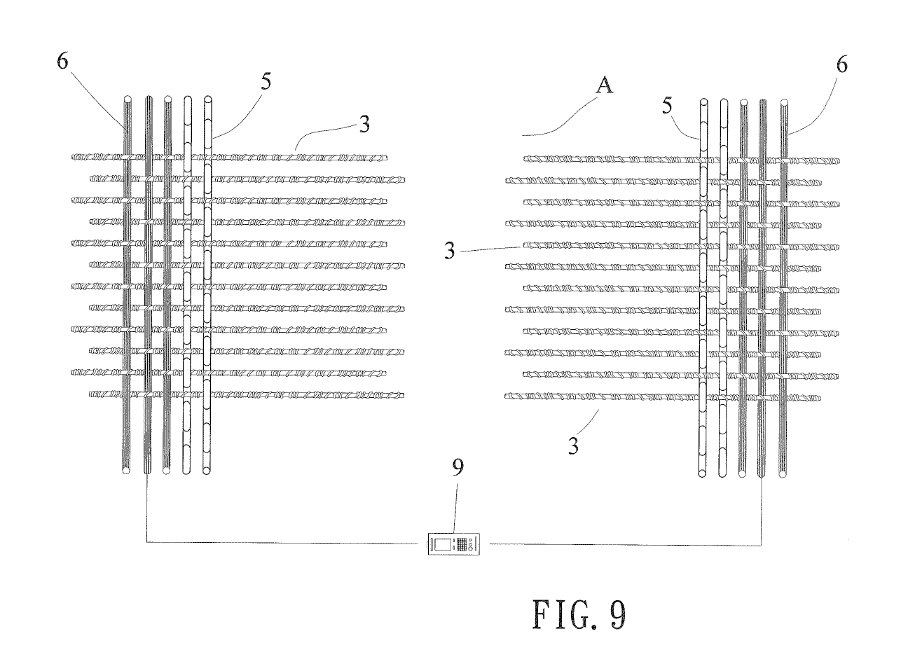

First, please refer to FIGS. 1-7 and 9, which are diagrams showing a heating pad for melting snow on roads according to this invention.

The heating pad 4 comprises:
at least a conductive heating fabric A comprising nonconductive textile yarns 5 and multiple metal conductive wires 6 disposed on two sides of the nonconductive textile yarns 5 as warps as well as conductive yarns 3 as wefts, wherein the conductive yarns 3 each has a nonconductive axial yarn 1 as well as a fine metal filament 2 spirally winding the axial yarn 1, and the conductive yarns 3 and the metal conductive wires 6 are alternatively woven;
a fixed wrapping cloth layer 41 for combining and fixing a wrapping cloth of the conductive heating fabric A and electrically connecting the adjacent conductive heating fabrics A; and
an upper insulating layer 42 and a lower insulating layer 43 correspondingly wrapping outside the conductive heating fabric A and the fixed wrapping cloth layer 41, wherein the conductive heating fabric A is fixed first, and a connecting port 44 connecting to the conductive heating fabric A is set up on the outside of the upper insulating layer 42 and the lower insulating layer 43.

Accordingly, the heating pad 4 is laid on a trail or a lane outside a garage in a cold snowing area, and the connecting port 44 is connected to an output wire 91 of a power supply unit 9 to generate heat for melting snow after electricity is conducted.

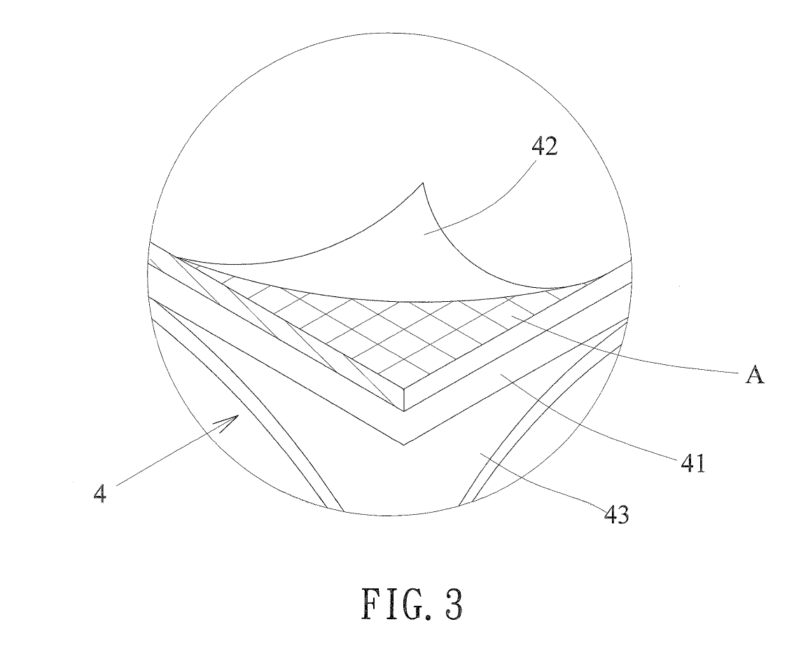

Please refer to FIGS. 3-7. The manufacturing process of the conductive heating fabric A is further illustrated below. The conductive heating fabric A comprises nonconductive textile yarns 5 and metal conductive wires 6 distributed on two sides thereof as warps as well as conductive yarns 3 as wefts. The conductive yarns 3 each comprises:
a nonconductive axial yarn 1 composed of multi-core filaments; and
a fine metal filament 2 spirally winding on the axial yarn 1, made of a conductive metal fine filament, such as a fine filament made of Au, Ag, Cu, or an alloy of W and Mo, as well as having a diameter of 0.02-0.12 mm preferably, wherein the fine metal filament 2 is guided by a device to spirally wind on the axial yarn 1 to form a stretchable and flexible conductive yarn 3.

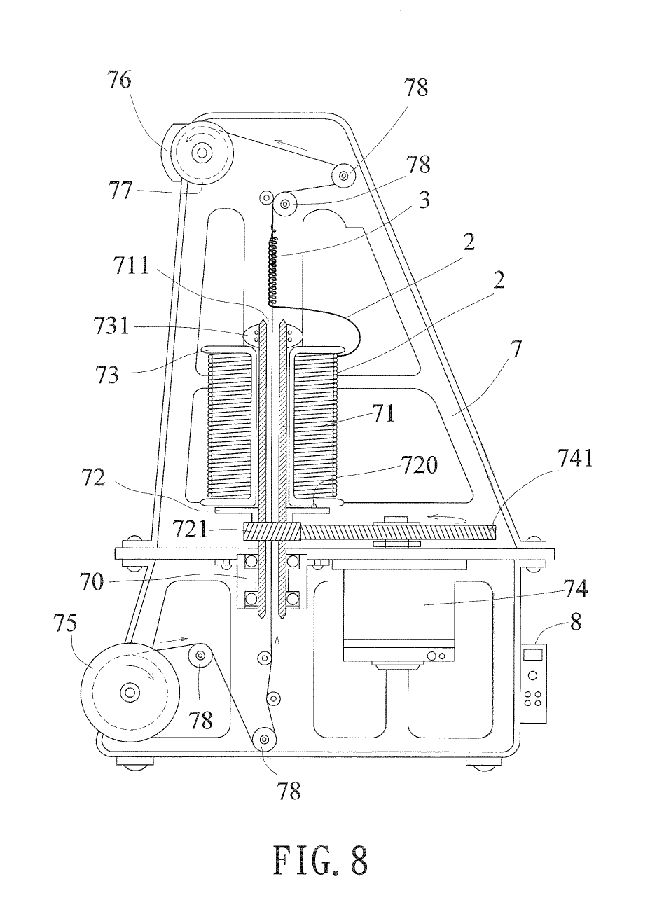

Please refer to FIG. 8, the device of manufacturing conductive yarns is shown FIG. 8. The device comprises:
a pedestal 7, a shaft seat 70 on the pedestal 7, an axial rod 71 embedded in the shaft seat 70 and having a through hole 711 in the central, a base 72 sleeved on the axial rod 71, a rotating wheel 721 set below the base 72, a reel 73 wound by the fine metal filament 2 and embedded above the base 72, a stopper 731 used for limiting the reel 73 and sleeved on the axial rod 71, a first motive power source 74 set up on the base 72, a driving wheel 741 driven by the first motive power source 74 and engaged with the rotating wheel 721, a spindle seat 75 wound by the axial yarn 1 and set below the base 72, and a second motive power source 76 set above the pedestal 7 for driving a furling wheel 77 for rotating and receiving the conductive yarn 3. The axial yarn 1 may correspondingly penetrate the central through hole 711 and spirally wound by a fine metal filament 2 to form the conductive yarn 3.

Please refer to FIG. 8. When the device is actually used to manufacture the conductive yarns 3, the nonconductive yarn 1 firstly rotates on the spindle seat 75, and then guided by several guiding wheels 78 to penetrate the central hole 711 of the axial rod 71. The axial yarn 1 is furled by the furling wheel 77 through the guiding wheels 78. A reel 73 furled by a fine metal filament 2 is embedded in the base 72. A limit lug 720 is disposed on the base 72. The limit lug 720 is used to embed and fix the reel 73. The axial rod 71 is sleeved in a stopper 731 for limit the reel 73. The fine metal filament 2 rotates on the axial yarn 1 in the beginning. A controller 8 is used to correspondingly control the first motive power source 74, the second motive power source 76, as well as the operation and the rotating rate (0-4800 rpm) of the furling wheel 77. The axial rod 71 can be driven by the first motive power source 74 to drive the rotation of the reel 73. At the same time, the second motive power source 76 drives the furling wheel 77 to rotate and pull the axial yarn 1, so that the fine metal filament 2 is parabolically thrown out to spirally rotate outside the axial yarn by following the high speed of the device. Accordingly, the nonconductive axial yarn 1 moves up for each 1 cm, the fine metal filament 2 winds on the axial yarn 1 for 70-125 turns to form the conductive yarn 3 being capable of electrically conducting and heat generating. The furling wheel 77 is used to furl the finished conductive yarn 3.

Please refer to FIGS. 1-7 and 9. The conductive yarn 3 can be used in woven cloth, such as flat textiles or blending textiles, to be wefts thereof. The warps may be various nonconductive textile yarns 5 with different colors. Then, various conductive heating fabrics having properties of electricity conducting, heat generating, good softness, pattern weaving, color dyeing, and pattern printing may be formed. Moreover, the conductive yarn 3 may be used to manufacture various yarn body with different diameters to be used in different textile products according to the different diameters thereof. For example, thicker conductive yarns 3 may be woven with thicker general yarns to form various heating blankets or heating pads, which is electricity conducting and heat generating, for melting snow on roads.

The principle and function of electricity conducting and heat generating of the conductive yarns in this invention is explained below.

When various fabrics is spun or woven, dozens of metal conductive wires 6 are used as conducting wires in the warps. The conductive wires 6 are distributed on two sides of the fabrics in a width of 0.6-1 cm, and may be made of fine Cu filaments or Ag filaments having a diameter of 0.05-0.12 mm. The central part of the conductive heating fabric A adapts generally nonconductive textile yarns 5, which may be with different colors and materials to form fabrics with various colors, patterns and dyeing. The wefts of the conductive heating fabric A adapts conductive yarns 3 having an axial yarn 1 made by multi-core filaments and a fine metal filament 2 spirally winding on the axial yarn 1. The fine metal filaments 2 spirally winding outside the conductive yarns 3 and the metal conductive wires 6 are alternatively woven to form a good electricity conducting path. The electricity of the metal conductive wires 6 disposed on two sides of the conductive heating fabric A is supplied by a power supply 9 in AC or DC form with 0-24 V to make the conductive heating fabric A generate heat. The voltage (V), current (A), temperature (T), and time can be fine-tuned by a computer to let the conductive heating fabric A generate the desired temperature (0-65° C.). Therefore, the yarns of the whole conductive heating fabric A can uniformly generate the desired temperature to have advantages of electricity saving, as well as not being harmed by electric shock and electromagnetic wave.

The heating pad for melting snow on roads of this invention is a soft and retractable heating pad for melting snow on roads. The heating pad may be laid on trails, sidewalks, and lanes outside garages. The heating pad may be further linked with a sensor 10. The sensor 10 may be a temperature sensor or a weight sensor. When the temperature is too low or the accumulated snow is too thick, the heating pad can generate heat to melt snow, and thus the heating pad is safe and easy to be used outdoors by people.

Moreover, the conductive heating fabric A using the conductive yarn 3 may be tailored in the weft's direction to be used, and the tailored length may be optional. The tailored conductive heating fabric is connected in parallel with the metal conductive wires on two sides. After the electric power is provided in series, another conductive heating fabric A is formed. The conductive heating fabric A may be used in daily life for against cold. For example, the heating fabric A may be used as bed sheets, mattresses, blankets, cushions, curtains, and wall covering, or may be woven to form blankets, carpets and heating pad for melting snow on roads. The conductive heating fabric A may be used to provide warm air indoors without construction, and thus it is very safe and convenient.

What is claimed is:

1. A heating pad for melting snow on roads, the heating pad comprising:
at least a conductive heating fabric comprising nonconductive textile yarns and multiple metal conductive wires disposed on two sides of the nonconductive textile yarns as warps as well as conductive yarns as wefts, wherein each of the conductive yarns has a nonconductive axial yarn as well as a fine metal filament spirally winding the axial yarn, and the conductive yarns and the metal conductive wires are alternatively woven in directions of warps and wefts;
a fixed wrapping cloth layer for combining and fixing a wrapping cloth of the conductive heating fabric and electrically connecting the adjacent conductive heating fabrics; and
an upper insulating layer and a lower insulating layer correspondingly wrapping outside of the conductive heating fabric and the fixed wrapping cloth layer, wherein the conductive heating fabric is fixed first, and a connecting port connecting to the conductive heating fabric is set up on the outside of the upper and lower insulating layers,
whereby the heating pad is laid on a trail or a lane outside a garage in a cold snowing area, and the connecting port is connected to an output wire of a power supply unit to generate heat for melting snow after electricity is conducted.

2. The heating pad of claim 1, wherein the upper and lower insulating layers are made of an insulating material selected from plastic, rubber and silicone.

3. The heating pad of claim 1, wherein electricity of the conductive heating fabric is provided by a 0-24 V DC power supply.

4. The heating pad of claim 1, wherein the metal conductive wires of the conductive heating fabric are distributed in a range of 0.6-1 cm on two sides.

5. The heating pad of claim 1, wherein a diameter of the metal conductive wires is between 0.05-0.12 mm.

6. The heating pad of claim 1, wherein each centimeter (cm) of the nonconductive axial yarn is wound by 70-125 circles of the fine metal filament.

7. The heating pad of claim 1, wherein the conductive heating fabric is sewn by a machine on the fixed wrapper cloth layer.

8. The heating pad of claim 1, wherein the fine metal filament is made of a conductive material selected from Au, Ag, Cu, and an alloy of W and Mo.

9. The heating pad of claim 1, wherein the heating pad is further connected to a sensor for turning on the heating pad, and the sensor is a temperature sensor or a weight sensor.

10. The heating pad of claim 2, wherein the heating pad is further connected to a sensor for turning on the heating pad, and the sensor is a temperature sensor or a weight sensor.

11. The heating pad of claim 4, wherein the heating pad is further connected to a sensor for turning on the heating pad, and the sensor is a temperature sensor or a weight sensor.

12. The heating pad of claim 5, wherein the heating pad is further connected to a sensor for turning on the heating pad, and the sensor is a temperature sensor or a weight sensor.

13. The heating pad of claim 6, wherein the heating pad is further connected to a sensor for turning on the heating pad, and the sensor is a temperature sensor or a weight sensor.
